(19) United States
(12) Patent Application Publication
(10) Pub. No.: US 2021/0170731 A1
(43) Pub. Date: Jun. 10, 2021

(54) LAMINATE INCLUDING SODIUM POLYACRYLATE, AND RELATED SYSTEMS AND METHODS

(71) Applicant: BAP Investors, LC, Chestnut Ridge, NY (US)

(72) Inventors: Michael Oprins, North Bend, WA (US); Peter Schumacher, Seattle, WA (US); Victor Davila, San Gabriel, CA (US)

(21) Appl. No.: 17/115,590

(22) Filed: Dec. 8, 2020

Related U.S. Application Data
(60) Provisional application No. 62/945,544, filed on Dec. 9, 2019.

(51) Int. Cl. B32B 27/14; B32B 5/16; B32B 3/30; B32B 37/12; B32B 27/30; C09J 7/24; C09J 7/38

(52) U.S. Cl. CPC B32B 27/14; B32B 5/16; B32B 3/30; B32B 37/12; B32B 27/306; C09J 2431/00; C09J 7/381; B32B 2451/00; B32B 2264/0228; B32B 2037/1253; C09J 2433/006; C09J 7/24

(57) ABSTRACT

A laminate for forming objects that include Sodium Polyacrylate includes an adhesive substrate and a layer of Sodium Polyacrylate powder. The adhesive substrate includes a first surface facing a first direction away from the substrate, a second surface facing a second direction away from the substrate, and a thickness defined by the distance between the first surface and the second surface. The Sodium Polyacrylate is adhered to at least one of the first and second surfaces.

### CROSS-REFERENCE TO RELATED APPLICATIONS AND INCORPORATION BY REFERENCE

This application claims priority from U.S. Provisional Patent Application 62/945,544 filed 9 Dec. 2019 and titled “PROCESS FOR MAKING SODIUM POLYACRYLATE INTO SHEET FORM, AND RELATED DEVICES AND SYSTEMS”. This application also incorporates by this reference the entirety of U.S. Provisional Patent Application 62/945,544.

### BACKGROUND

Sodium Polyacrylate is a super absorbent polymer molecule. It is often used on movie and theater sets to create artificial snow by adding water to it. The conventional process for making Sodium Polyacrylate generates the molecule in powder form. In powder form, Sodium Polyacrylate is used to mimic snow falling on a set of a movie or theater, to absorb liquid in diapers, to absorb industrial spills, and to thicken hair gel and other products.

Unfortunately, because Sodium Polyacrylate typically exists in powder form and expands as much 40 times its original volume when exposed to water or other liquids, Sodium Polyacrylate is often used in situations where its expansion can occur uncontrolled. For example, the powder is often loosely contained in a pouch, such as a diaper, or not contained at all, such as when it is used to mimic snow falling on a movie set. When the Sodium Polyacrylate powder is held in a pouch, the powder inside the pouch may be moved around within the pouch, and when the powder is exposed to water or other liquid the powder expands uncontrollably within the pouch. When the Sodium Polyacrylate powder is used to mimic falling snow, the powder is loosely held in a bowl or trough, and when the powder is exposed to water the powder expands uncontrollably. Then, the water-expanded powder is poured over the movie set from a place high above the set. In these situations, the final form of the water-expanded Sodium Polyacrylate is simply an amorphous pile of highly expanded powder.

Thus, there is a need for a way to control the expansion Sodium Polyacrylate when it's exposed to water or other liquids, to allow one to control the final form of the expanded Sodium Polyacrylate.

### SUMMARY

In one aspect of the invention, a laminate for forming objects that include Sodium Polyacrylate includes an adhesive substrate and a layer of Sodium Polyacrylate powder. The adhesive substrate includes a first surface facing a first direction away from the substrate, a second surface facing a second direction away from the substrate, and a thickness defined by the distance between the first surface and the second surface. The Sodium Polyacrylate is adhered to at least one of the first and second surfaces.

With Sodium Polyacrylate adhered to at least one of the substrate's surfaces, the expansion of the Sodium Polyacrylate powder is confined to the direction away from the surface; and, after expanding, the Sodium Polyacrylate remains attached to the substrate. This allows one to form an object from the laminate and then expand the Sodium Polyacrylate to give the appearance that the object is covered in snow. For example, one can form a two or three-dimensional snowflake out of the substrate, then adhere Sodium Polyacrylate to one or more of the substrate's surfaces. Then, when one adds water to the Sodium Polyacrylate, the Sodium Polyacrylate expands while remaining adhered to the substrate. In this manner, the snowflake may hang from a branch of a tree, such as a Christmas tree, without losing all of the expanded Sodium Polyacrylate, which makes the snowflake appear more real.

In another aspect of the invention, a method for forming objects that include Sodium Polyacrylate includes: a) forming a substrate by spreading an adhesive into a film, the substrate having a first surface facing a first direction away from the substrate, a second surface facing a second direction away from the substrate, and a thickness defined by the distance between the first surface and the second surface; b) placing Sodium Polyacrylate onto at least one of the first and second surfaces; and c) curing the adhesive to adhere the Sodium Polyacrylate to the at least one of the first and second surfaces.

### BRIEF DESCRIPTION OF THE DRAWINGS

FIG. 1 shows a view of a laminate that includes a layer of Sodium Polyacrylate, according to an embodiment of the invention.

FIG. 2 shows a cross-sectional view of the laminate shown in FIG. 1, according to an embodiment of the invention.

FIG. 3 shows a view of another laminate that includes a layer of Sodium Polyacrylate, according to another embodiment of the invention.

FIG. 4 shows a cross-sectional view of the laminate shown in FIG. 3, according to an embodiment of the invention.

### DETAILED DESCRIPTION

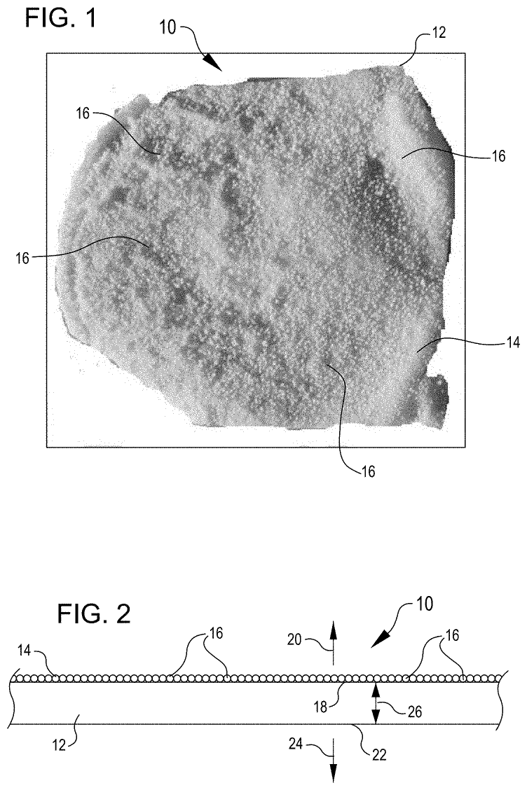

FIG. 1 shows a view of a laminate 10 that includes Sodium Polyacrylate and that one can use to form an object, according to an embodiment of the invention. The laminate 10 includes an adhesive substrate 12 and a layer 14 of Sodium Polyacrylate powder 16 (only four labeled for clarity) that is adhered to a surface of the substrate 12. Once formed, the laminate 10 may be shaped into any desired object, such as a two or three-dimensional snowflake, and/or combined with any other object, such as a sheet of plywood, and will not lose the expanded Sodium Polyacrylate 16 when the Sodium Polyacrylate 16 is exposed to water or other liquids.

With Sodium Polyacrylate 16 adhered to the substrate 12, the expansion of the Sodium Polyacrylate powder 16 is confined to the direction away from the substrate 12; and, after expanding, the Sodium Polyacrylate 16 remains attached to the substrate 12. This allows one to form an object from the laminate 10 and then expand the Sodium Polyacrylate 16 to give the appearance that the object is covered in snow. For example, one can form a two or three-dimensional snowflake out of the substrate 12, then adhere Sodium Polyacrylate 16 to one or more of the substrate's surfaces. Then, when one adds water to the Sodium Polyacrylate 16, the Sodium Polyacrylate 16 expands while remaining adhered the substrate 12. In this manner, the snowflake may hang from a branch of a tree, such as a Christmas tree, without losing all of the expanded Sodium Polyacrylate 16, which makes the snowflake appear more real. For another example, one can form a sheet out of the substrate 12, mount the substrate 12 to a sheet of plywood, then adhere Sodium Polyacrylate 16 to the exposed side of the substrate 12. When one then adds water to the Sodium Polyacrylate 16, the Sodium Polyacrylate 16 expands while remaining adhered the substrate 12. In this manner, the laminate 10 and plywood can appear to be a patch or field of snow.

The laminate 10 is formed by first forming the adhesive substrate 12. This is accomplished by spreading the adhesive into a film, or any other form such as a plate or curved object. Then, the adhesive substrate 12 may be partially cured before placing the Sodium Polyacrylate 16 onto the substrate 12, or not (as discussed in greater detail in conjunction with FIG. 2). After the Sodium Polyacrylate 16 is placed on the adhesive substrate 12, the adhesive substrate 12 is cured some more to adhere the Sodium Polyacrylate 16 to the adhesive substrate 12.

Other embodiments of the laminate 10 are possible. For example, the laminate 10 may include a third layer or carrier adhered to a portion of the adhesive substrate 12 that does have Sodium Polyacrylate adhered to it.

FIG. 2 shows a cross-sectional view of the laminate 10 shown in FIG. 1, according to an embodiment of the invention. The adhesive substrate 12 includes a first surface 18 facing a first direction 20 away from the substrate 12, a second surface 22 facing a second direction 24 away from the substrate 12, and a thickness 26 defined by the distance between the first surface 18 and the second surface 22. The Sodium Polyacrylate 16 is then adhered to at least one of the first and second surfaces 18 and 22.

The adhesive substrate 12 may be configured as desired. For example, in this and other embodiments the adhesive substrate 12 includes Polyvinyl Acetate and has a thickness 26 that is about 1.5 millimeters. More specifically, the film of Polyvinyl Acetate has a substantially uniform thickness, and the first and second surfaces 18 and 20 are substantially planar. In addition, the adhesive substrate 12 may be cured to any desired degree before, during, and/or after the application of the Sodium Polyacrylate powder 16 to provide the substrate 12 any desired degree of flexibility, and to provide any desired degree of constraint in the expansion of the Sodium Polyacrylate 16. For Polyvinyl Acetate and other adhesives, the more complete the cure of the adhesive 12 is, the more rigid or stiff the film of the substrate 12 will be. During formation of the laminate 10, a rigid or stiff adhesive 12 will prevent much of each of the individual kernels of Sodium Polyacrylate powder 16 from sinking into the adhesive substrate 12. This can reduce the strength of the Sodium Polyacrylate's adherence to the substrate 12. This can also reduce the ability of the adhesive substrate 12 to constrain the Sodium Polyacrylates expansion when it's exposed to water or other liquids. Whereas, a pliable or soft adhesive substrate 12 during the application of the Sodium Polyacrylate 16 will allow more of each of the individual kernels of Sodium Polyacrylate powder 16 to sink into or contact the adhesive substrate 12. This can increase the strength of the Sodium Polyacrylate's adherence to the substrate 12, and increase the ability of the adhesive substrate 12 to constrain the Sodium Polyacrylates expansion when it's exposed to water or other liquids. Likewise, after formation of the laminate 10, a rigid or stiff adhesive 12 will confine the use of the laminate 10 to objects that will not experience much deformation. Whereas, a pliable or soft adhesive substrate 12 after formation of the laminate 10 will allow the use of the laminate 10 for objects that might experience much deformation.

In this and other embodiments, the adhesive substrate 12 is uncured when the Sodium Polyacrylate 16 is placed on the first surface 18 and then partially cured to form the laminate 10. In other embodiments, the adhesive is fully cured to form the laminate 10. And in still other embodiments the adhesive is partially cured when the Sodium Polyacrylate 16 is placed on the first surface 18.

The Sodium Polyacrylate 16 may be distributed on the first and/or second surface 18 and/or 22 in any desired patter and concentration. For example, in this and other embodiments the Sodium Polyacrylate 16 is evenly distributed throughout the whole first surface 18, and substantially covers all of the first surface 18. In other embodiments, the Sodium Polyacrylate 16 may be distributed throughout the first surface 18 but may be distributed in a higher concentration in a region of the first surface 18, and in a lower concentration in another region. In yet other embodiments, the Sodium Polyacrylate 16 may be distributed throughout a region of the first surface 18, and absent in another region of the first surface 18.

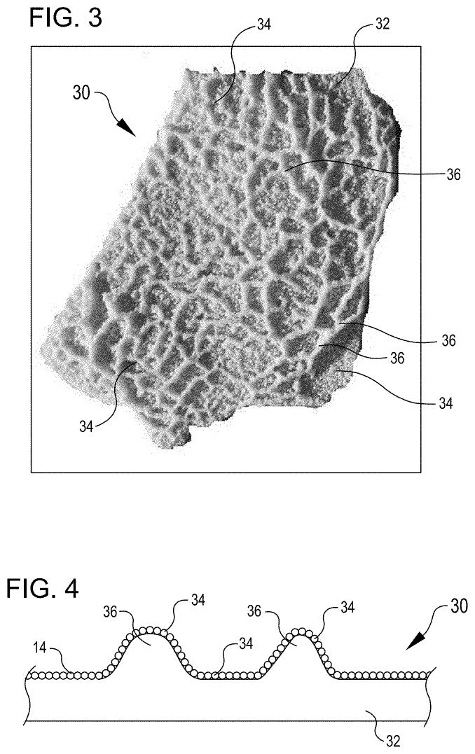

Each of FIGS. 3 and 4 shows a view of another laminate 30 that includes a layer 32 of Sodium Polyacrylate 34, according to another embodiment of the invention. FIG. 3 shows a perspective view, and FIG. 4 shows a cross-sectional view. The laminate 30 is similar to the laminate 10 shown in FIGS. 1 and 2, except that the adhesive substrate 32 does not have a uniform thickness throughout, but rather ridges 36 where the thickness of the adhesive substrate 32 is greater than the thickness of the substrate 32 elsewhere. Also, the distribution of the Sodium Polyacrylate 34 is more concentrated in the regions of the substrate's surface that includes the ridges 36, than the regions of the substrate's surface that does not. When the Sodium Polyacrylate 34 is exposed to water and other liquid, the Sodium Polyacrylate 34 that is adhered to the ridges 36 expands and more fully covers the ridge 34 than the Sodium Polyacrylate 34 that is adhered to the other regions. This, in turn, provides the appears of a build of snow or a snow drift, or it may help give shape to the object that the laminate 30 is used to make.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A laminate for forming objects that include Sodium Polyacrylate, the laminate comprising:
an adhesive substrate having a first surface facing a first direction away from the substrate, a second surface facing a second direction away from the substrate, and a thickness defined by the distance between the first surface and the second surface; and
a layer of sodium polyacrylate powder adhered to at least one of the first and second surfaces.

2. The laminate of claim 1 wherein the adhesive substrate includes a pressure sensitive adhesive.

3. The laminate of claim 1 wherein the adhesive substrate includes Polyvinyl Acetate.

4. The laminate of claim 1 wherein the adhesive substrate includes Polyvinyl Acetate that is partially cured.

5. The laminate of claim 1 wherein the adhesive substrate includes Polyvinyl Acetate that is fully cured.

6. The laminate of claim 1 wherein the thickness of the substrate is uniform throughout.

7. The laminate of claim 1 wherein the thickness of the substrate is not uniform throughout.

8. The laminate of claim 1 wherein the substrate includes a ridge on the first surface.

9. The laminate of claim 1 wherein the layer of Sodium Polyacrylate has a uniform thickness throughout.

10. The laminate of claim 1 wherein the layer of Sodium Polyacrylate does not have a uniform thickness throughout.

11. The laminate of claim 1 further comprising a carrier adhered to at least one of the following: the substrate and the layer of Sodium Polyacrylate.

12. The laminate of claim 1 wherein the laminate has a shape that resembles a snowflake.

13. The laminate of claim 1 wherein the laminate has a shape that resembles a snowy field.

14. A method for forming objects that include Sodium Polyacrylate, the method comprising:
forming a substrate by spreading an adhesive into a film, the substrate having a first surface facing a first direction away from the substrate, a second surface facing a second direction away from the substrate, and a thickness defined by the distance between the first surface and the second surface;
placing Sodium Polyacrylate onto at least one of the first and second surfaces; and
curing the adhesive to adhere the Sodium Polyacrylate to the at least one of the first and second surfaces.

15. The method of claim 14 wherein the adhesive is partially cured before placing the Sodium Polyacrylate onto at least one of the first and second surfaces.

16. The method of claim 14 wherein forming the substrate includes spreading the adhesive such that a portion of the film has a thickness that is greater than another portion of the film.

17. The method of claim 14 wherein forming the substrate includes forming a ridge in film.

18. The method of claim 14 wherein placing the Sodium Polyacrylate onto at least one of the first and second surfaces includes distributing Sodium Polyacrylate in powder form across a region of the surface.

19. The method of claim 14 wherein placing the Sodium Polyacrylate onto at least one of the first and second surfaces includes uniformly distributing Sodium Polyacrylate in powder form across the whole surface.

20. The method of claim 14 wherein placing the Sodium Polyacrylate onto at least one of the first and second surfaces includes not uniformly distributing Sodium Polyacrylate in powder form across the whole surface.

21. The method of claim 14 further comprising adhering a carrier to at least one of the following: the film and the Sodium Polyacrylate.

22. The method of claim 14 further comprising forming an object that resembles a snowflake.

23. The method of claim 14 further comprising forming an object that resembles a snowy field.
